(19) United States
(12) Patent Application Publication
(10) Pub. No.: US 2014/0334304 A1
(43) Pub. Date: Nov. 13, 2014

(54) CONTENT CLASSIFICATION OF INTERNET TRAFFIC

(71) Applicants: Hui Zang, Cupertino, CA (US); Adrian D. Fritsch, Los Altos, CA (US); Mark Crovella, Wayland, MA (US)

(72) Inventors: Hui Zang, Cupertino, CA (US); Adrian D. Fritsch, Los Altos, CA (US); Mark Crovella, Wayland, MA (US)

(21) Appl. No.: 14/026,512

(22) Filed: Sep. 13, 2013

Related U.S. Application Data
(60) Provisional application No. 61/822,490, filed on May 13, 2013.

(51) Int. Cl. H04L 12/851

(52) U.S. Cl. CPC H04L 47/2441
USPC 370/235

(57) ABSTRACT

A content-classification model is constructed using sampling methods to create training sets of classifiers using imbalanced and/or large-volume training data; the model maps network source addresses and/or flow sizes to target applications and is applied to network traffic to identify contents thereof and estimate a tonnage of traffic corresponding to a given application.

### CROSS-REFERENCE TO RELATED APPLICATIONS

This application claims priority to and the benefit of U.S. Provisional Patent Application Ser. No. 61/822,490, filed on May 13, 2013, which is hereby incorporated herein by reference in its entirety.

### TECHNICAL FIELD

Embodiments of the present invention relate to systems and methods for analyzing network traffic and, more particularly, to constructing and applying content-classification models to said traffic.

### BACKGROUND

Internet-service providers and other network owners, administrators, or maintainers may wish to classify traffic on their networks (i.e., data flowing in their networks) to better manage the traffic. For example, an Internet-service provider may give precedence to a real-time data stream, such as video chat, by giving it more bandwidth and/or assigning it a lower transit time than other, less time-critical data streams (e.g., file downloads). The Internet-service provider must first, however, analyze the data streams to determine their type and/or application.

One way to determine the type/family of a data stream is by direct inspection of data packets in the stream; information contained in the packets or packet headers, such as MIME type and source URL, may reveal the type/family of data in the stream. Because this method requires the disassembly and inspection of individual packets, however, it may be slow, require large amounts of processing power, and/or not scale well for large amounts of data. Other properties of the data in the stream (e.g., amount of data transmitted, transmit time, source, and destination) may be more easily measured or determined, but these properties do not contain information about the type/family of the data.

Another way to classify traffic is to build a classifier model and apply it to the unknown data stream. A classifier model may be built by analyzing a set of “training data”—i.e., a predetermined set of many data points that maps known “input variables” (e.g., source/destination) to known “output values” (e.g., type/family). Once built, a data stream of unknown type/family is applied to the model; given the data stream's source or destination, for example, the model predicts the type/family of the stream.

Usually, the internet traffic is not evenly distributed over the types/families; some types/families may have more packets/flows than the others. In order for the classifier model to accurately predict the correct type/family of the data streams, the set of training data must be large enough to encompass many representative examples of each type and family. Given the large size of typical training-data sets, however, it is often prohibitively difficult or time-consuming to parse the entire set. Because it is preferred to keep enough examples of the types and families that are associated with smaller numbers of examples (e.g., the minority types/families), sampling is usually carried on the types and families that have a greater number of examples (e.g., the majority types/families). Existing systems, therefore, may sample only a subset of the training data and build the model based on the sampling. For example, existing systems related to machine learning use imbalanced data, in which the models are constructed by independently sampling several subsets from a majority class based on (for example) distance vector calculation and/or developing multiple classifiers based on a combination of each subset with the minority class data. These systems may select a random set of samples from each subset and compute a mean feature vector of these samples to designate a cluster center; the remaining training samples are presented one at a time and, for each sample, a Euclidean distance vector between it and each cluster center is computed. The random sampling method and the distance calculating method is time- and resource-consuming, however, and is not suitable for large data sets. Consequently, there is a need for a system and method that provides easy and fast construction and application of a content-classification model to identify contents and enable users to manage internet traffic.

### SUMMARY

Described herein are various embodiments of methods and systems for identifying data classes and data-transfer amounts (“tonnage”) related to the data classes in a set of flow records. In some embodiments, given a list of data flows, the number of flows associated with a particular service (e.g., a video-on-demand service) may be identified, along with the amount of data transferred for that service.

In various embodiments, the basic principle of operation is to construct and apply a content-classification model that may be applied to a network traffic flow to identify data in the traffic flow corresponding to the application of interest. The model may be constructed based on a training data set with a known mapping between the application and data relating thereto; for example, the model may identify “signature” aspects of data associated with the application, e.g., network source address and flow size (wherein flow size refers to the number of bytes, number of packets, or any other similar metric of the size of a flow of data). Accordingly, embodiments of the invention may involve storing a training data set comprising a mapping of network source address and flow size to a target processor-executable application; computationally constructing a model that relates network source address and flow size to the target application; applying the model to a network traffic flow of data to identify data in the network traffic flow corresponding to the application; and computationally estimating a tonnage of traffic in the network traffic flow corresponding to the application.

The model may be constructed by, for example, sampling the majority class of the training data at a plurality of undersampling rates, and selecting the undersampling rate that maximizes a performance metric. The performance metric may further comprise a product of an F-score and a tonnage error metric (i.e., an error metric that represents the accuracy of the tonnage estimation). Constructing the model may further include, without limitation, dividing the space of the source addresses into a first set of bins and the space of the flow sizes into a second number of bins; and for each of the bins, undersampling the training data corresponding thereto at a rate dependent on the amount of training data that falls in the bin.

Various embodiments may further comprise reconfiguring a network based at least in part on the estimated tonnage of traffic; for example, reconfiguring the network may comprise increasing or decreasing the network bandwidth allocated with the target application or re-routing traffic in the network associated with the target application to increase or decrease the delivery time of the traffic.

As the terms are used herein, a particular type of traffic to be detected and/or identified is the “true class”; if there are two or more classes and they are skewed and/or imbalanced (i.e., one or more classes are larger than the others), the class(es) with more examples are the majority class(es) and the class(es) with fewer examples are the minority class(es). The true class may be a minority class; in this case, all other classes are majority class(es) (also known as false classes).

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 illustrates the identification of a content type of the data in accordance with various embodiments of the present invention;

FIG. 2 illustrates a receiver-operating characteristic (ROC) curve having a representative relationship between a sampling rate and a number of true and false positives in accordance with various embodiments of the present invention;

FIG. 3 illustrates a method for classifying content and managing internet traffic in accordance with various embodiments of the present invention;

FIG. 4 illustrates an exemplary two-by-two matrix of cells for examining training data in accordance with various embodiments of the present invention;

FIG. 5 illustrates an exemplary content classification computing system in accordance with various embodiments of the present invention; and

FIG. 6 illustrates a method for classifying content and managing internet traffic in accordance with one embodiment of the present invention.

### DETAILED DESCRIPTION

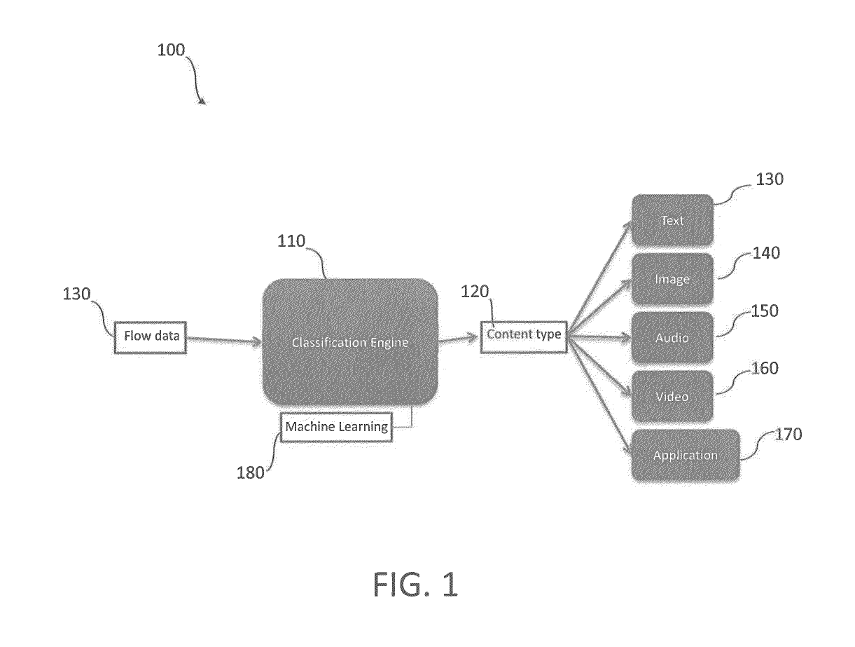

FIG. 1 conceptually illustrates an exemplary system 100 that includes a classification engine 110 used to identify a content type 120 of input flow data 130. In some embodiments, the content type 120 includes generic categories of data, such as text 130, image 140, audio 150, video 160, and application data 170; the content type 120 may also include application or “family” types such as particular video-on-demand services, audio-streaming services, video-chat services, and remote-desktop services. In some embodiments, the classification engine 110 includes a machine learning algorithm 180 to construct training data, as explained in greater detail below. In one embodiment, a set of training data is constructed using a packet-inspection technique such as deep-packet inspection (“DPI”). In other embodiments, the set of training data is received from a third party or other source and tailored to the expected data categories. More generally, any system or method for constructing the set of training data is within the scope of the present invention. The training data may relate to Internet traffic or traffic on any other network, and it may include web-browsing data, email, video-game data, peer-to-peer file transfer or communication data, or any other type of network data. The data 130 may include highly skewed classes (i.e., the data 130 may be an imbalanced dataset)—that is, certain types, categories, or other classes of the data may be significantly more represented in the data 130 than other classes. The set of training data may be large and/or comprehensive enough to include examples of each class (even the under-represented classes). In one embodiment, a data classifier is constructed by inspecting the address of the origin of each data flow (e.g., server IP address) and the size of each data flow (e.g., number of bytes transmitted) to predict the type, family, or other class of the data flows.

In some instances, sampling the data in the training set to build the classifier model may lead to errors in using the model to predict the type/family of data streams, however. For example, a classifier may be required to identify a particular type/family; examples from this type/family are labeled as “true” and all the other examples labeled as “false.” The model may correctly identify a data stream as belonging to the true class (a “true positive) or may correctly identify a data stream as not belonging to the true class (a “true negative”). The model may also, however, incorrectly identify a data stream as belonging to the true class (a “false positive”) or incorrectly identify a data stream as not belonging to the true class (a “false negative”).

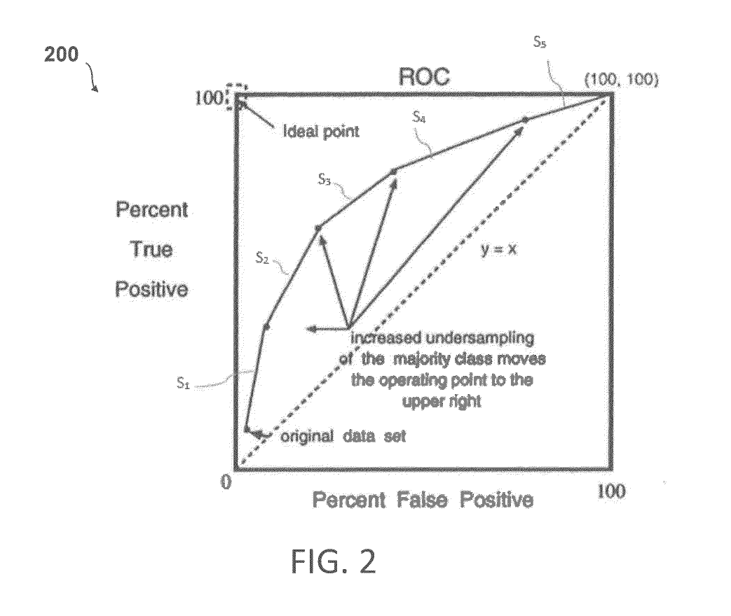

A representative relationship between sampling rate and number of true and false positives is represented in FIG. 2, which illustrates a receiver-operating characteristic (“ROC)” curve 200. The ROC curve 200 relates a true positive percentage along the ordinate to a false positive percentage along the abscissa; the points on the curve correspond to the performance of a classifier on any given distribution. Increased undersampling of the majority class moves the operating point to the upper-right-hand side of the figure—in other words, first increases in undersampling sections S₁, S₂ cause the number of false positives to increase slightly while causing a significant decrease in false negatives. Further increases in undersampling S₂-S₅ may be less beneficial, as indicated by the upper-right area of the graph, because the number of false positives increases more quickly and the number of false negatives decreases more slowly. In the figure, each segment S1-S5 may correspond to an equal or similar fraction degree of undersampling.

The ROC curve 200 shown in the FIG. 2 is one illustrative example; other shapes and configurations of ROC curves are possible. Particularly in some cases, increased undersampling results in only a slight decrease in false negatives but a sharp increase in false positives, thereby producing an overall decrease in the F-score (or other performance metrics). In one embodiment, these conditions apply to examining the (IP address×byte size) space, which may have very uneven coverage in the training data. A blanket undersampling of the majority class, therefore, may turn low-sampled areas into unsampled areas, and the unsampled areas may produce a disproportionately high number of false positives. On the other hand, performing no undersampling (or performing only very light undersampling) may require a prohibitively high amount of computing and/or wall-clock time (e.g., 5-50 hours of computing time) to build a classifier model.

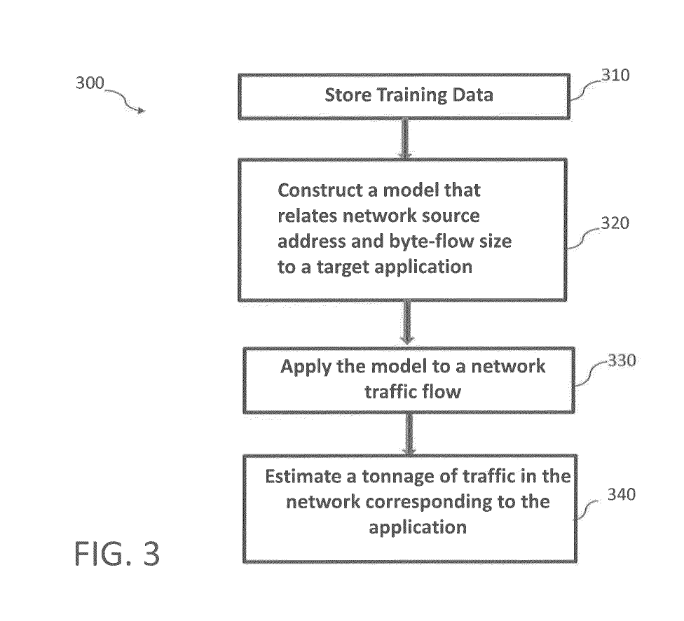

A representative method 300 for classifying content and managing internet traffic in accordance with embodiments of the present invention appears in FIG. 3. In a first step 310, training data is stored in a computer memory. As described above, the training data may map network source address and/or flow size to a target processor-executable application; the training data may be generated by (for example) packet inspection of a data flow (or any other means known in the art) and/or acquired from a third party. In a second step 320, a model that relates network source address and/or byte flow size to the target application is computationally constructed (by a computing system, as described in greater detail below). In some embodiments of the present invention, the model is constructed by sampling false-class data uniformly at a variety of different sampling rates and selecting the best rate; in other embodiments of the present invention, the source address and/or flow size spaces are partitioned into a pluraltiy of ranges or “bins,” and samples are chosen for each bin. Both of these embodiments are explained in greater detail below. In one embodiment, once a set of training data is selected, a classifier model is created based thereon using any method known in the art, such as a machine-learning algorithm (e.g., random-forest or SVM). In a third step 330, the model is applied to a network traffic flow of data to identify data in the network traffic flow corresponding to the application (by, for example, classifying the traffic flows as true or false), and in a fourth step 340, a tonnage of traffic in the network traffic flow corresponding to the application is computationally estimated. Certain of these steps may be repeated if, for example, the estimation is inaccurate (or less accurate than a desired threshold or metric), if updated training data is obtained or generated, or for any other reason. For example, a new sampling rate may be selected in the second step 320 and a new classifier model may be created based thereon; the new model may then be applied to network traffic flow (step 330) and a new estimation created (step 340).

In one embodiment of the present invention, the false class data is sampled uniformly at a variety of different sampling rates; a classifier model is constructed using the training data sampled at each rate, and a performance metric is measured for each model. The sampling rate having the best performance metric may be selected and used to construct the training data set for the content-classification model. In the case in which there are two skewed classes (i.e., true and false classes), the sampling rate is applied to the majority class of the two. In the case in which there are more than two classes, one or more majority classes may be sampled, and they may be sampled at the same rate or different rates. Therefore, the variety of sampling rates or the combinations thereof may be tested for one or more than one data type or data family. If one particular family of data is of primary importance, the sampling rates may be tested for only that class.

In one embodiment, the performance metric tested for each sampling rate is given below in Equation (1).

score=F×(1−|TE|) (1)

F refers to the F-score (also known as the F1-score), as defined below in Equation (2), and TE is the tonnage error, as defined below in Equation (3).

$$\begin{matrix}F = \frac{\begin{matrix}2 \times ( number of true positives ) \times \\ ( number of true negatives )\end{matrix}}{\begin{matrix}( number of true positives ) + \\ ( number of true negatives )\end{matrix}} & ( 2 ) \\ T E = \frac{\begin{matrix}( tonnage of false positives ) - \\ ( tonnage of false negatives )\end{matrix}}{\begin{matrix}( tonnage of tru e positives ) + \\ ( tonnage of false negatives )\end{matrix}} & ( 3 )\end{matrix}$$

The sampling rate having the largest score, in accordance with Equation (1), is selected. Other performance metrics may be used; the present invention is not limited to only the metric appearing in Equation (1).

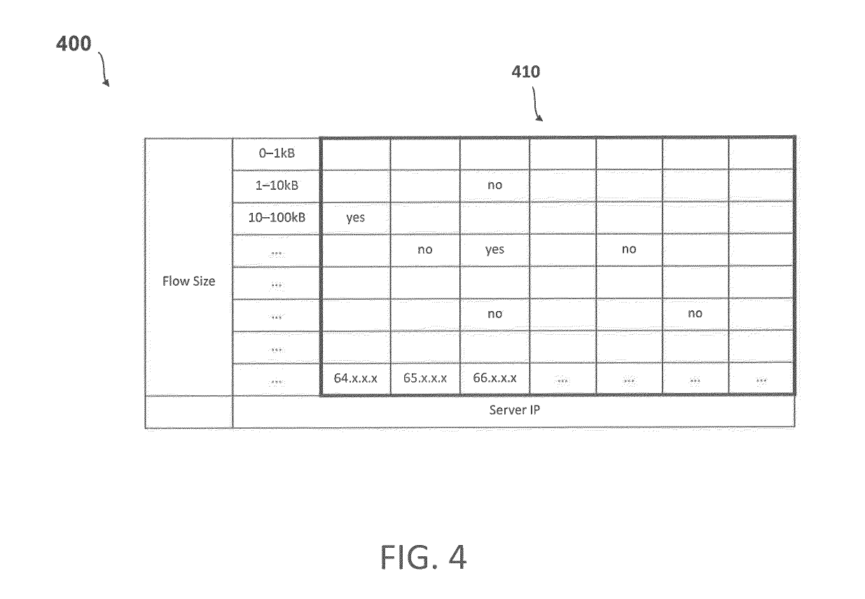

FIG. 4 illustrates the use of source address (e.g., server IP address) and download total byte count (i.e., download flow size) as a feature set 400 to construct a matrix of “yes” or “no” entries from which a classification model may be built. In this embodiment, the server-IP space and the flow-size space are partitioned into a plurality of ranges or “bins” collectively indicated at 410. The bins may be selected to be uniform across a known or expected server-IP space and flow-size space or may be selected based on the server IP addresses and flow sizes present in the training data; the bins 410 may represent equal-sized portions of each space or may vary in size.

The contents of the matrix are populated by examining the training data. A selected item of training data is added to the matrix at its appropriate cell, given its server IP address and flow size. If the selected item of training data corresponds to a desired application (e.g., a particular video-on-demand service), a “yes” or similar positive attribute is added to the cell (in addition to any already-present data or earlier-added attributes). If the selected item of training data does not correspond to the desired application, a “no” or similar negative attribute is added to the cell.

A single, overall “yes” or “no” attribute is assigned to each cell based on the tally of yes and no entries recorded for the cell. In one embodiment, an overall “yes” is assigned to the cell if the recorded yes entries outnumber the no entries. In other embodiments, an overall “yes” is assigned to the cell if the recorded yes entries cross a given threshold (e.g., 45% or 55%). The threshold may be determined empirically by selecting the threshold that produces the lowest overall tonnage error (using, e.g., Equation (3)). In one embodiment, data may be exponentially separated by the independent variables such as IP address, flow size, etc. Some cells may be left empty because no training example is mapped to these cells. In one embodiment, the performance metric described above (e.g., the F1 score or other metric) may be used to help construct and/or modify the completed matrix.

Each cell may be undersampled at a different rate. In one embodiment, a cell having a large number of total data points (i.e., total number of recorded yes and no entries) is undersampled at a higher rate than a cell having a small number of total data points. The sampling rate may vary dynamically; as a cell receives more and more data points, for example, its undersampling may increase accordingly. In one embodiment, the undersampling does not further increase once it reaches a certain amount or rate. In another embodiment, all cells are undersampled to a fixed number C, wherein C may be, e.g., 1 or 2. In other words, all the cells may end up with one or two samples per cell. Cells in the “true” class (the “yes” cells) and cells in the false class (the “no” cells) may be sampled down to the same C or different values of C. For example, cells in the “true” class get sampled to C_true and cells in the “false” class get sampled to C_false. In one embodiment, C_true=C_false=1; in another embodiment, C_true=2 and C_false=1. In another embodiment, all “no” cells get undersampled to a fixed number C, wherein C may be, e.g., C=1 or 2, while the “yes” cells are not sampled, i.e., the same number of examples as indicated by that cell get added to the training set.

Once populated, the matrix may be used to construct one or more training sets. The feature set may include the server-IP range and flow-size range. For each cell that has been populated, a variable O may be used to represent the outcome (i.e., yes/no); if the number of samples is C, C examples are added to the training set. Each example added to the training set may be of the form (IP-range-index, flow-size-range-index, O).

A classifier model may then be trained on this training set. To use the classifier model, real data may be preprocessed, and features like server IP and flow size may be converted to the server-IP-range index and flow-size-range index before the data is be classified. Furthermore, the present invention is not limited to use of only source IP address or flow size as inputs or to the use of only two-dimensional (2D) matrices; any sort of input training data and/or any order of matrix (.e.g., 3D, 4D, etc.) are within the scope of the present invention.

The estimated tonnage may be used by the operator/administrator/owner of a network to reconfigure the network accordingly. For example, if an application associated with the tonnage is deemed high-priority (for, e.g., real-time applications like video chat or video-on-demand), the network may be reconfigured to increase the bandwidth of the data and/or reduce the time-of-flight/end-to-end delay associated with the data. If an increase in the tonnage is detected, more resources may be reallocated accordingly, and vice versa. If the application is low-priority (e.g., file downloads or peer-to-peer file-sharing traffic), the network may be reconfigured to decrease the bandwidth or time-of-flight, and increases in the tonnage may prompt further decreases in the network resources.

The identified contents and estimated tonnage may help a network operator to deploy value-adding services at selected locations. For example, if an operator detects a large volume of video or video-on-demand traffic at a certain geographical region, the operator can deploy a video-optimization service (or place a video optimization instrument at the service center) for that region. In addition, the identified contents may be injected to real-time network management and control systems to change network policies to achieve quality of service and related goals. For example, video and video-on-demand services can be given higher priority and the data streams hence can be queued into a higher-priority queue than text data streams. The identified content type can help the network operator to determine additional processing/rerouting of the content. For example, video contents can be rerouted to a video traffic optimizer. For another example, when a network congestion event occurs, image traffic can be rerouted to a bandwidth optimizer that reduces the resolution of the images instead of dropping them. The terms “Internet data” and “network data” are used interchangeably herein, it being understood that the utility of the invention is not limited to only Internet environments. In one embodiment, the training data set may be optimized to apply to the classification model; conventional methods of machine learning or other algorithms may also be used to generate the initial training data, as one of skill in the art will understand.

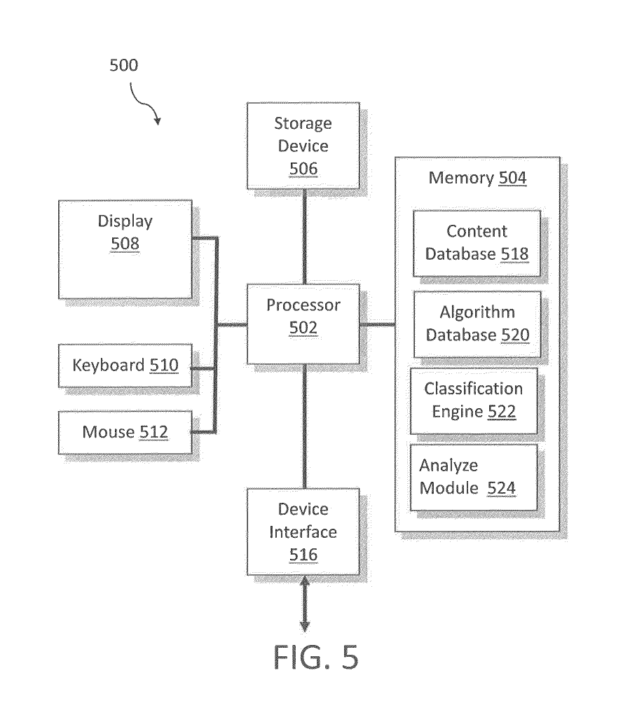

An exemplary content classification system for implementing embodiments of the invention appears in greater detail in FIG. 5. A computing device 500 may generally be any device or combination of devices capable of processing internet data using techniques described herein. The computing device 500 may include a processor 502 having one or more central processing units (CPUs), volatile and/or non-volatile main memory 504 (e.g., RAM, ROM, or flash memory), one or more mass storage devices 506 (e.g., hard disks, or removable media such as CDs, DVDs, USB flash drives, etc. and associated media drivers), a display device 508 (e.g., a liquid crystal display (LCD) monitor), user input devices such as keyboard 510 and mouse 512, and one or more device interfaces 516 that facilitate communication between these components and other components or computing devices.

The main memory 504 may be used to store instructions and algorithms to be executed by the processor 502, conceptually illustrated as a group of modules. These modules generally include an operating system (e.g., a Microsoft WINDOWS, Linux, or APPLE OS X operating system) that directs the execution of basic system functions (such as memory allocation, file management, and the operation of mass storage devices). The various modules may be programmed in any suitable programming language, including, without limitation high-level languages such as C, C++, C#, OpenGL, Ada, Basic, Cobra, Fortran, Java, Lisp, Perl, Python, Ruby, or Object Pascal, or low-level assembly languages.

The memory 504 may further store input and/or output content data in a content database 518, which is associated with execution of the instructions as well as additional information used by the various software applications. In the illustrated embodiment 500, the memory 504 stores a database 520 of training data for use in constructing models. A classification engine 522 stores content classification models (including feature index, sampling rate, cell instructions, etc.) for separating training data and constructing classifier models, and an analysis module 524 informs a user of the results of traffic analysis to facilitate reconfiguration of network usage, management of the network, etc.

The central computing device 500 is an illustrative example; variations and modifications are possible. Computers may be implemented in a variety of form factors, including server systems, desktop systems, laptop systems, tablets, smart phones or personal digital assistants, and so on. A particular implementation may include other functionality not described herein, e.g., wired and/or wireless network interfaces, media playing and/or recording capability, etc. Further, the computer processor may be a general-purpose microprocessor, but depending on implementation can alternatively be, e.g., a microcontroller, peripheral integrated circuit element, a customer-specific integrated circuit (“CSIC”), an application-specific integrated circuit (“ASIC”), a logic circuit, a digital signal processor (“DSP”), a programmable logic device such as a field-programmable gate array (“FPGA”), a programmable logic device (“PLD”), a programmable logic array (“PLA”), smart chip, or other device or arrangement of devices.

Further, while central computing device 500 is described herein with reference to particular blocks, this is not intended to limit the invention to a particular physical arrangement of distinct component parts. The processing unit may provide processed contents or other data derived from more than one classification algorithm with various combinations of feature matrixes to the computer for further processing. In some embodiments, the processing unit sends display control signals generated based on the identified content to the computer, and the computer uses these control signals to automatic trigger the reconfiguration and management of network usage.

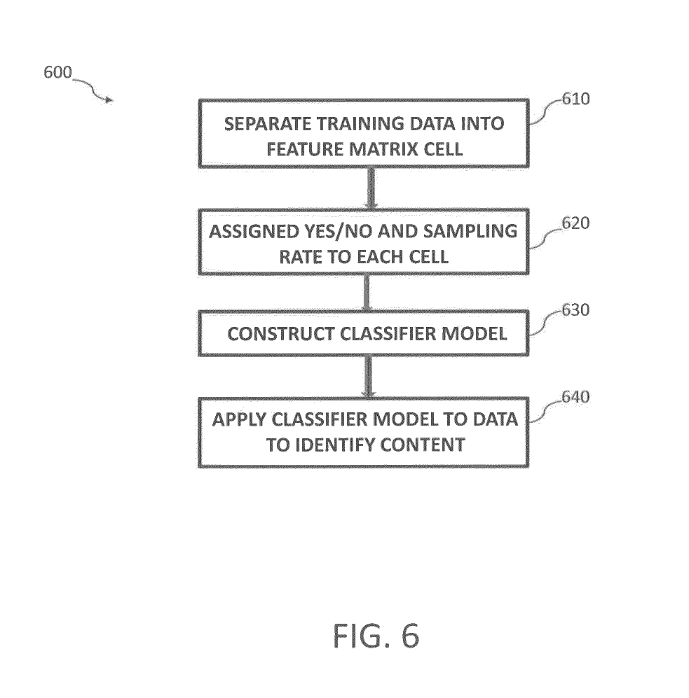

A method 600 for classifying content and managing internet traffic in accordance with one embodiment of the present invention appears in FIG. 6. Training data may be provided to the system by any of the methods described above or using other suitable algorithm or technique to generate the initial training data set. For example, the training data may be generated by packet inspection of a data flow and/or acquired from a third party. In a first step 610, training data is stored in a computer memory and entered into the cells of a feature matrix. As described above, the feature matrix may include variables such as network source address and/or flow size that are relevant to a target processor-executable application. In a second step 620, instructions or rules (for example, yes, no, etc.) and sampling rates are assigned to each cell of the feature matrix. In a third step 630, a classifier model is constructed with the training data set The training data set may be optimized (prior to or in parallel with the construction of the model) by machine-learning or other algorithms known in the art to improve the accuracy of the model. The optimization may include, for example, identification of input variables (e.g., network source address and/or flow size) correlated to output variables (e.g., application type or name) and/or elimination of uncorrelated input/output variables. In a fourth step 640, the model is applied to a network traffic flow of data to identify data in the network traffic flow and manage network corresponding to the application.

Certain embodiments of the present invention were described above. It is, however, expressly noted that the present invention is not limited to those embodiments, but rather the intention is that additions and modifications to what was expressly described herein are also included within the scope of the invention. For example, it may be appreciated that the techniques, devices and systems described herein with reference to examples employing light waves are equally applicable to methods and systems employing other types of radiant energy waves, such as acoustical energy or the like. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for constructing a content-classification model, the method comprising:
storing, in a computer memory, a training data set comprising a mapping of network source address and flow size to a target processor-executable application;
computationally constructing a model that relates network source address and flow size to the target application;
applying the model to a network traffic flow of data to identify data in the network traffic flow corresponding to the application; and
computationally estimating a tonnage of traffic in the network traffic flow corresponding to the application.

2. The method of claim 1, wherein constructing the model comprises:
sampling the majority class of the training data at a plurality of undersampling rates; and
selecting the undersampling rate that maximizes a performance metric.

3. The method of claim 2, wherein the performance metric comprises a product of an F-score and an error metric for tonnage estimation.

4. The method of claim 1, wherein constructing the model comprises:
dividing a space of the source addresses into a first set of bins and a space of the flow sizes into a second number of bins;
for each of the bins, undersampling the training data corresponding thereto at a rate dependent on the amount of training data in the bin.

5. The method of claim 4, wherein dividing the space of inputs into bins comprises using dimensional matrices of three or more dimensions.

6. The method of claim 4, wherein dividing the space of inputs into bins comprises linear division, exponential division, or a combination thereof.

7. The method of claim 1, further comprising reconfiguring a computer network based at least in part on the estimated tonnage of traffic.

8. The method of claim 7, wherein reconfiguring the computer network comprises increasing or decreasing a network bandwidth associated with the application or re-routing traffic in the network associated with the application to increase or decrease the transit time of the traffic.

9. A system for constructing a content-classification model, the system comprising:
a database for storing a training data set comprising a mapping of network source address and flow size to a target processor-executable application;
a processor configured for:
i. constructing a model that relates network source address and flow size to the target application;
ii. applying the model to a network traffic flow of data to identify data in the network traffic flow corresponding to the application; and
iii. estimating a tonnage of traffic in the network traffic flow corresponding to the application.

10. The system of claim 9, wherein the processor is further configured to construct the model by:
sampling the majority class of the training data with a plurality of undersampling rates; and
selecting the undersampling rate that maximizes a performance metric.

11. The system of claim 9, wherein the performance metric comprises a product of an F-score and a tonnage metric.

12. The system of claim 9, wherein the processor is further configured to construct the model by:
dividing a space of the source addresses into a first set of bins and a space of the flow sizes into a second number of bins;
for each of the bins, undersampling the training data corresponding thereto at a rate dependent on the amount of training data that falls in the bin.

13. The system of claim 10, wherein the processor is further configured to construct the model by:
dividing a space of the source addresses into a first set of bins and a space of the flow sizes into a second number of bins;
for each of the bins, undersampling the training data to yield a fix number of training data that falls in the bin.

14. The system of claim 13, wherein dividing the space of inputs into bins comprises using dimensional matrices of three or more dimensions.

15. The system of claim 13, wherein dividing the space of inputs into bins comprises linear division, exponential division, or a combination thereof.

16. The system of claim 9, wherein the processor is further configured to take an action based at least in part on the estimated tonnage of traffic.

17. The system of claim 16, wherein the action is reconfiguring a computer network.

18. The system of claim 17, wherein reconfiguring the computer network comprises increasing or decreasing a network bandwidth associated with the application or re-routing traffic in the network associated with the application to increase or decrease the transit time of the traffic.
